(19) United States
(12) Patent Application Publication
(10) Pub. No.: US 2018/0078437 A1
(43) Pub. Date: Mar. 22, 2018

(54) DEVICE FOR POSITIONING A BEDRIDDEN PATIENT

(71) Applicant: FONDAZIONE IRCCS CA' GRANDA-OSPEDALE MAGGIORE POLICLINICO, Milano (IT)

(72) Inventor: Mauro PANIGADA, Milano (IT)

(21) Appl. No.: 15/558,909

(22) PCT Filed: Feb. 26, 2016
(86) PCT No.: PCT/IB2016/051052

§ 371 Date: Sep. 15, 2017

(30) Foreign Application Priority Data
Mar. 16, 2015 (IT) MI2015A000395

(51) Int. Cl. A61G 7/07; A61G 7/075

(52) U.S. Cl. CPC A61G 7/07; A61G 7/0755

(57) ABSTRACT

A device is for positioning a bedridden patient, in particular for keeping the lateral Trendelenburg position or another safety position. In particular, a medical device includes at least a first shaped pillow (1) adapted to support a patient's back and to keep the patient in a lateral position with a predetermined inclination angle. The pillow (1) can be extended in width along a lateral direction (L2) so as to tailor the pillow to the patient's body size.

The present invention relates to a device for positioning a bedridden patient, in particular for keeping the lateral Trendelenburg position or another safety position.

### BACKGROUND ART

So-called VAP (Ventilator-Associated Pneumonia) is the complication most frequently associated with tracheal intubation and mechanical ventilation in patients hospitalized in intensive care.

Preliminary studies on animal models have shown that the orientation of the trachea and the tracheal tube under the horizontal plane prevents the onset of VAP with respect to the currently recommended orientation by at least 30°. In adults, the trachea and the endotracheal tube may be kept under the horizontal plane by means of the lateral Trendelenburg position.

At least four pillows are normally used by nursing staff in order to keep the lateral Trendelenburg position. Such a position is difficult to be kept because the sedated patient with muscular relaxation tends to spontaneously take the supine position. This requires continuous assistance by nurses to reposition the patient. Furthermore, the tailoring of the pillows to the needs of different patients, in particular to their body size, requires particular attention and considerable experience of the health care staff.

A further difficulty arises from the need to turn the patient onto the other side at regular intervals, which requires a complete rearrangement of all pillows.

A problem addressed by the present invention is thus that of providing a medical device which simplifies the operations of positioning and repositioning a bedridden patient and keeping him/her in the Trendelenburg position or in a similar safety position.

### SUMMARY OF THE INVENTION

These and other problems are solved by a medical device as set forth in the appended claims, the definitions of which form an integral part of the present description.

Therefore, a subject of the invention is a medical device comprising at least one shaped pillow adapted to keep a patient in a lateral position with a predetermined inclination angle and characterized in that it can be extended laterally in width so as to tailor it to the patient's body size.

A second subject of the invention is a medical device comprising a back supporting pillow as defined in claim 1 and at least one pillow chosen from a pillow for the patient's head and a pillow for the patient's legs, where said pillows are joined together by removable connection means.

Another subject of the invention is a kit comprising at least two pillows, one of which is as defined in claim 1, and the at least one other pillow is a leg pillow or a head pillow.

A yet further subject of the invention is a kit comprising pillows as defined in claims 1 and 2, and removable connection strips to keep said pillows joined together when used on the patient.

Further features and advantages of the present invention will become apparent from the description of some embodiments, given below by way of non-limiting example, with reference to the following figures:

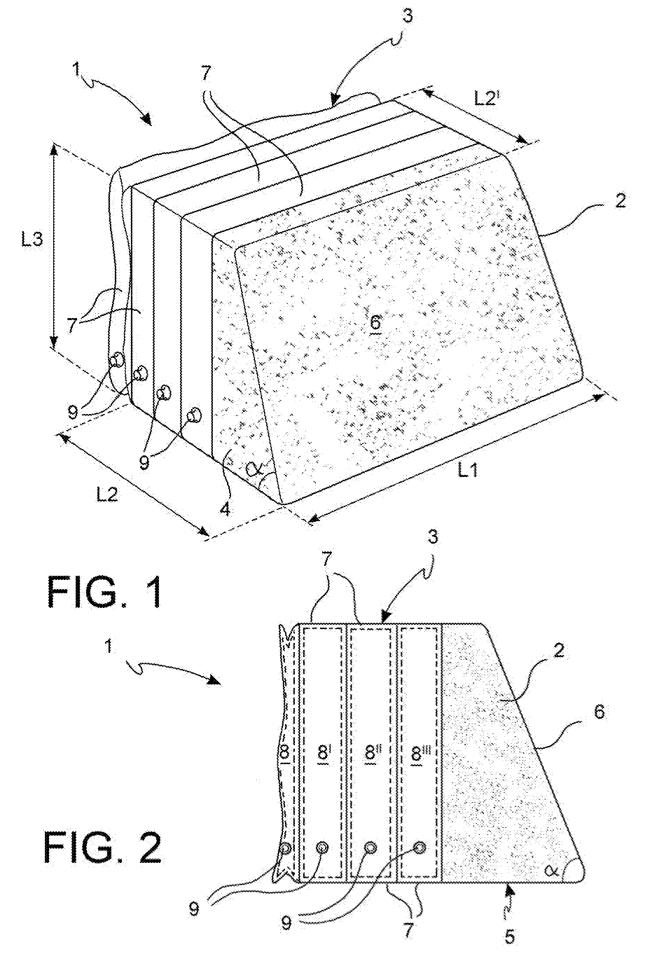

FIG. 1 is a perspective view of a shaped pillow according to the invention;

FIG. 2 is a side phantom view of the pillow in FIG. 1;

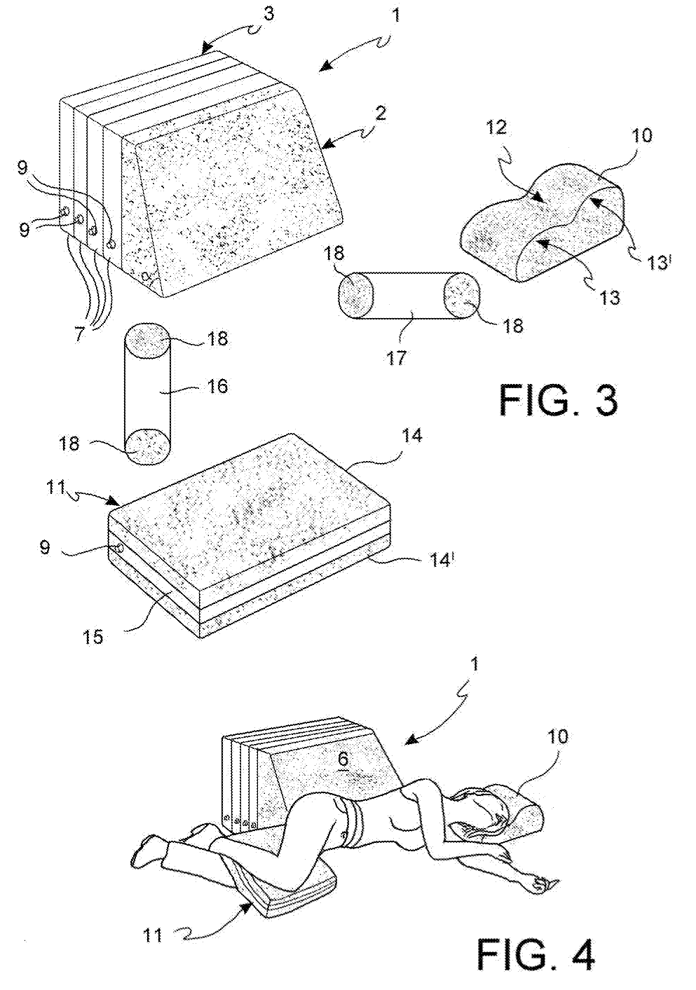

FIG. 3 is a perspective view of a kit comprising the pillow of the invention;

FIG. 4 is a perspective view of the kit of the invention in use on a patient;

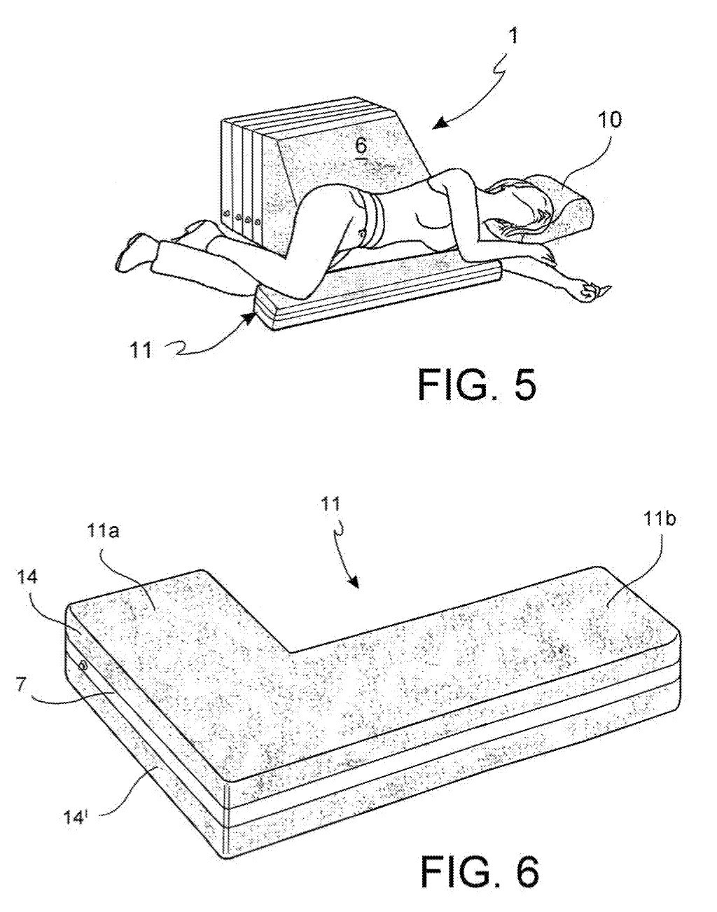

FIG. 5 is a perspective view of the kit of the invention in use on a patient according to a different embodiment;

FIG. 6 is a perspective view of a pillow for legs and arms according to a further embodiment.

### DETAILED DESCRIPTION OF THE INVENTION

With reference to the figures, the shaped pillow of the invention, indicated by reference numeral 1 as a whole, comprises a shaped portion 2 and an expandable portion 3.

Pillow 1 develops along three directions:
a first longitudinal direction L1 (length), substantially parallel to the patient's body;
a second lateral direction L2 (width), substantially traversal to the patient's body, and
a third vertical direction L3 (height).

The shaped portion 2 is shaped so that the width L2′ at the level of the upper surface of pillow 1 is less than the width L2 at its base.

The shaped portion 2 consists of a body 4 having a rectangular base 5 and a substantially right-angled triangle shaped cross section. Therefore, body 4 has an inclined surface 6. Surface 6 forms the support surface for the patient's back.

In preferred embodiments, the inclination of surface 6 with respect to base 5 (angle α in the figures) is from 20° to 40°, or from 25° to 35°, or about 30°. It has been noted that such an inclination angle ensures a better position for the patient.

The shaped portion 2 is made of a flexible material so as to be soft and accommodating and not to create abrasions for the patient.

In preferred embodiments, the material of the shaped portion 2 of pillow 1 is an elastomer, in particular a foam elastomer. For example, natural or synthetic rubber or a viscoelastic foam, in particular of the bedsore-prevention type, may be used. In certain embodiments, such a material may be a latex, e.g. of the memory shape type.

At least the shaped portion 2, or only the support surface 6 thereof, is preferably covered with a breathable fabric, such as cotton, flax or other fabric used in the medical field. In some embodiments, a synthetic fabric will be used, such as an acrylic fiber fabric or a knitted pile fabric of the “Spandex” type.

In some embodiments, at least the shaped portion of pillow 1 or, if used, the fabric coating thereof, comprises an antibacterial compound, such as for example an antibacterial active compound either absorbed, adhered or bound to the surface thereof by means of covalent bonds.

Examples of antibacterial active compounds are penicillins, aminoglycosides, quinolone antibiotics, tetracyclines, chloramphenicol, sulfacetamide, sulfamethazine, sulfadiazine, sulfamerazine, sulfamethizole, erythromycin, clarithromycin, rifamycin, rifampicin, ceftazidime, amoxicillin, amoxicillin trihydrate, clavulanic acid, vancomycin hydrochloride, teicoplanin, linezolid, colistin and chlorhexidine. For example, such compounds may be bound to the surface to be treated by means of cyclodextrins, according to technologies known to those skilled in art.

In other embodiments, the antibacterial compound either comprises or consists of Ag⁺ ions. For example, a silver yarn or an organometallic complex may be used, in which Ag⁺ is coordinated. Examples of complexes of this type are described in EP 2 024 117 B1 to NM TECH LTD NANOMATERIALS.

In some embodiments, the antibacterial compound is based on bioactive synthetic polymers and natural protein substances with positive charges.

The expandable portion 3 of pillow 1 comprises one or more sections 7 (four sections 7 in the figure). When the sections 7 are more than one, they are separated from one another so as to create a series of expandable modules, each being able to be expanded by a suitable inflation fluid, so as to adjust the thickness of pillow 1 along the lateral direction L2 according to needs. Indeed, it is known that according to the patient's body size and the size of the bed on which the patient is laying, it may be necessary to modify the size, in particular the lateral dimensions, of pillow 1 in order to obtain an appropriate support. Indeed, the pillow must be arranged so as to be supported between the patient's back and the bed containment barriers, so as to remain fixed in place, whereby the void may vary as a function of the indicated parameters.

For this purpose, each section 7 internally comprises a chamber 8, 8′, 8″, 8′″, connected to the outside by a spout 9, for the inflation fluid to enter. A check valve is preferably arranged at spout 9. The chambers 8, 8′, 8″, 8′″ may also comprise a second valve (not shown) for draining the inflation fluid, or the valve associated with spout 9 may be a charging/discharging valve actuatable on command.

FIG. 3 shows a kit comprising the pillow 1 according to the invention, a second pillow 11 to be placed between the patient's legs, and a third pillow 10 for the patient's head.

The shape of the third pillow 10 is such as to ensure an adequate support to the patient's head, in particular in the Trendelenburg position which involves a downward inclination (negative inclination) of about 5°. Therefore, pillow 10 has a double hump shape 13, 13′ which has a middle depression 12 such as to allow the desired negative inclination (FIG. 4).

As shown on the drawing, the second pillow 11 may have a classic parallelepiped shape, but in other embodiments it may be circular, elliptical or have a different shape. Pillow 11 is placed between the patient's legs as shown in FIG. 4 or under the knee and the upper elbow as shown in FIG. 5, so as to support the knee and the upper elbow. For this purpose, the size of pillow 11 may be different according to different needs: wider and shorter in the case shown in FIG. 4, narrower and longer in the case shown in FIG. 5. Furthermore, in the latter case, pillow 11 may have a wider first portion 11a to support the leg and a narrower second portion 11b to support the arm without interfering with the patient's torso (FIG. 6).

In some embodiments, as shown in the figures, pillow 11 may also comprise at least one support portion 14, 14′ and at least one expandable portion 15. Two support portions 14, 14′ sandwiching the expandable portion 15 on the two sides thereof are shown in the figures, but in other embodiments a single support portion 14 may be provided.

The expandable portion 15 is similar to the expandable portion 3 of the first pillow 1, but will preferably consist of a single section 7 in which the chamber 8 for the inflation fluid is housed.

A spout 9 with check valve and charging/discharging valve is also included for the second pillow 11. In the first case, a valve (not shown) for discharging the fluid will be obviously included.

In some embodiments, the support portion(s) 14, 14′ are made of the same material as the support portion 2 of the first pillow 1 and may be similarly coated with a breathable fabric like those described above, possibly comprising an antibacterial compound as defined above.

The inflation fluid may be a gas or a liquid, preferably sterile and non-flammable.

In the case of a gas, any means may be included for inflating the chambers 8, such as a manual pump, a compressed air generator or a compressed air line, or a line of another fluid, having a pressure higher than atmospheric pressure.

An inert, non-flammable gas will be preferably used, such as for example nitrogen.

If the inflation fluid is a liquid, typically water, an appropriate pump will be used, which will both introduce the fluid and remove it at the end of use. Typically, the inflation liquid will be recycled. In such a case, it will preferably contain sanitizing substances.

The kit in FIG. 3 may further comprise a first connection strip 16 between the first pillow 1 and the second pillow 11 and a second connection strip 17 between the first pillow 1 and the third pillow 10.

The connection strips 16, 17 may be made of natural, artificial or synthetic fabric and are preferably removable (as shown in the figures). For this purpose, the strips 16, 17 comprise removable connection means 18 at the two ends, in particular the male portion or the female portion of a hook and loop system (known as Velcro® system), the complementary female or male portion being arranged on the lower surface of the pillows 1, 10, 11. With regard to the second pillow 11 for the patient's legs, such a complementary portion of the connections means will be positioned in a point to prevent the interference with the patient's body so as to ensure maximum comfort.

It is worth noting that the above-described hook and loop system is only one example of removable connection means 18. Other examples may be hook and eyelet systems, automatic buttons, magnetic coupling systems or the like.

The advantages of the pillows according to the invention and of the corresponding kit are apparent and already highlighted in part.

The first pillow 1 and the second pillow 11 comprise expandable modular portions, so as to adjust the width or thickness of the pillow, respectively, according to needs, i.e. as a function of the bed size and of the patient's body.

The removable connection means between the three pillows of the kit allow to keep them joined, making it easier to position them on the patient and keep him/her in the desired position. Indeed, the connection means avoid the leg pillow 11 from being inadvertently moved by the patient, thus altering the correct support position, for example. On the other hand, the fact that such connection means are removable facilitates the later storage of the kit in a cabinet or other container, by limiting the dimensions thereof.

As apparent from the shape of the pillows, the pillow kit according to the invention may be used for the patient resting either on the left or on the right side, which operation must be performed at regular intervals for a bedridden patient in the described conditions.

It is apparent that only some particular embodiments of the present invention have been described, to which those skilled in the art will be able to make all the changes required to adapt it to particular applications, without thereby departing from the scope of protection of the present invention.

1. A medical device comprising at least a first shaped pillow adapted to support a patient's back and to keep the patient in a lateral position with a predetermined inclination angle, wherein said pillow is extendable in width along a lateral direction so as to tailor said pillow to the patient's body size.

2. The medical device according to claim 1, further comprising a second pillow to support a patient's leg, and a third pillow to support the patient's head.

3. The medical device according to claim 1, wherein said first pillow comprises a shaped portion and an expandable portion along the lateral direction.

4. The medical device according to claim 3, wherein the shaped portion comprises a body having a rectangular base and a cross section substantially right-angled triangle-shaped, said body having an inclined surface.

5. The medical device according to claim 4, wherein the inclination of the surface with respect to the base ranges between an angle α of 20° and 40°.

6. The medical device according to claim 3, wherein the expandable portion of the first pillow comprises one or more sections mutually separated from one another, so as to create a series of expandable modules along the lateral direction, each of the modules being able to be expanded by inflation fluid, so as to adjust thickness of the pillow along the lateral direction according to needs.

7. The medical device according to claim 6, wherein each section comprises internally a chamber, connected to outside of the pillow by a spout, for inlet of the inflation fluid.

8. The medical device according to claim 7, wherein a check valve is arranged at the spout, and wherein the chambers comprise a second valve for discharge of the inflation fluid, or, the valve associated with the spout is a charging/discharging valve actuatable upon a command.

9. The medical device according to claim 2, wherein the second pillow has a parallelepiped, circular or elliptical shape, or the second pillow has a first portion with a larger width for supporting the leg, and a second portion with a smaller width for supporting the arm without interfering with the patient's torso.

10. The medical device according to claim 2, wherein the pillow comprises at least one support portion and at least one expandable portion, said expandable portion comprising at least one section in which a chamber is housed, in flow communication with outside of the pillow by a spout.

11. The medical device according to claim 2, wherein said shaped portion and said at least one support portion are made of a flexible material or of an elastomer or of an elastomeric foam.

12. The medical device according to claim 2, wherein at least the shaped portion and/or the at least one support portion or only the support surface thereof are coated with a breathable fabric, comprising cotton, flax, or other fabric used in the medical field.

13. The medical device according to claim 12, wherein at least the shaped portion or the at least one support portion or, where used, the fabric coating thereof, comprise an antibacterial compound or an antibacterial active compound absorbed, adhered or bound by covalent bonds or cyclodextrins to said surface.

14. The medical device according to claim 13, wherein said antibacterial compound or antibacterial active compound is selected from penicillins, aminoglycosides, quinolone antibiotics, tetracyclines, chloramphenicol, sulfacetamide, sulfamethazine, sulfadiazine, sulfamerazine, sulfamethizole, erythromycin, clarithromycin, rifamycin, rifampicin, ceftazidime, amoxicillin, amoxicillin trihydrate, clavulanic acid, vancomycin hydrochloride, teicoplanin, linezolid, colistin, chlorhexidine and Ag⁺ ions.

15. The medical device according to claim 2, wherein the third pillow has a double bump shape which has a middle depression to allow a negative inclination of about 5° to the patient's head.

16. The medical device according to claim 6, wherein the inflation fluid is a gas or a liquid, and the inflation fluid is inflammable and/or sterile.

17. The medical device according to claim 1, comprising a first removable connection strip between the first pillow and the second pillow (11) and a second removable connection strip between the first pillow and the third pillow.

18. The medical device according to claim 17, wherein the connection strips comprise, at two ends, removable connectors comprising: a male portion or a female portion of a hook and loop system, the complementary female or male portion being arranged on the lower surface of the pillows, or hook and eyelet systems, automatic buttons, or magnetic coupling systems.
